(19) United States
(12) Patent Application Publication
(10) Pub. No.: US 2018/0129077 A1
(43) Pub. Date: May 10, 2018

(54) BROW EYE FRAME

(71) Applicant: Anita Hunt, Silver City, NM (US)

(72) Inventor: Anita Hunt, Silver City, NM (US)

(21) Appl. No.: 15/345,447

(22) Filed: Nov. 7, 2016

(51) Int. Cl. G02C 11/02

(52) U.S. Cl. CPC G02C 11/02; G02C 2200/08

(57) ABSTRACT

A modular eyewear frame system for providing an adaptable eye frame accessory to be attached over eyewear frames to provide a means for modularly attaching panels to conceal a top front border from view.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of eyewear accessories and more specifically relates to a modular eyewear frame system.

### 2. Description of Related Art

With the development and progress of society, people's pursuit of beauty is also growing. People pursue environmental beauty, home beauty, and beauty apparel. Glasses, although a health care product, have also become a kind of fashion accessory. People want glasses with decorative features that allow the wearer to change in different environments, for different occasions, in response to their own preferences, and to complete an outfit. However, traditional frame and traditional optometric models have hindered the pursuit of beauty with glasses. High fashion sunglasses have been marketed that utilize various colors for the lens holding frame and a variety of geometric shapes for the lens holding frame. These fashion sunglasses are extremely expensive, and, thus, owning a number of pairs in various shapes and colors is prohibitive. A suitable solution is desired.

Several attempts have been made to solve the above-mentioned problems such as those found in U.S. Pat. No. 2,891,251 to Ebersole, Elbert H.; U.S. Pat. No. 5,321,442 to Gerry M. Albanese; and U.S. Pat. No. 4,878,749 to James E. McGee. This art is representative of eyewear accessories. However, none of the above inventions and patents, taken either singly or in combination, is seen to describe the invention as claimed.

### BRIEF SUMMARY OF THE INVENTION

In view of the foregoing disadvantages inherent in the known eyewear accessory art, the present invention provides a novel modular eyewear frame system. The general purpose of the present invention, which will be described subsequently in greater detail is to provide an adaptable eye frame accessory to be attached over the eyewear frame

A modular eyewear frame system is disclosed herein, in a preferred embodiment, comprising a panel having a body comprising a front surface and a back surface. The modular eyewear frame system comprises the panel. The panel is weather resistant. The panel horizontally extends along the top front border of the eyewear frame from a first-arm to a second-arm of glasses member. The panel comprises the body. The body is defined by the front surface and the back surface. The body of the panel is substantially planar. The body is also flexible to contour to the eyewear frame.

The panel is adapted to removeably couple via adhering to a top front border of an eyewear-frame. The panel contours to the top front border of the eyewear frame. The panel extends from the top front border of the eyewear frame to top-edge of each lens of the eyewear frame. The adhering comprises an adhesive substance. The adhesive substance is reusable. The adhesive substance comprises adhesive paste. The eyewear-frame is adapted to receive the panel with a plurality of decorative designs.

The modular eyewear frame system is useful for providing an adaptable eye frame accessory to be attached over the eyewear frame to provide a means for modularly attaching the panels to conceal the top front border from view. A method for using modular eyewear frame system is also disclosed herein.

The present invention holds significant improvements and serves as a modular eyewear frame system. Preferably, an eyewear accessory should provide an adaptable eye frame accessory to be attached over the eyewear frame and, yet would operate reliably and be manufactured at a modest expense. Thus, a need exists for a reliable modular eyewear frame system to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, modular eyewear frame system, constructed and operative according to the teachings of the present disclosure.

FIG. 1 shows a perspective view illustrating a modular eyewear frame system during an ‘in-use’ condition according to an embodiment of the disclosure.

FIG. 2 is a perspective view illustrating the modular eyewear frame system comprising a panel according to an embodiment of the present invention of the disclosure.

FIG. 3 is a perspective view illustrating the panel according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an eyewear accessory and more particularly to a modular eyewear frame system used to provide an adaptable eye frame accessory to be attached over an eyewear frame.

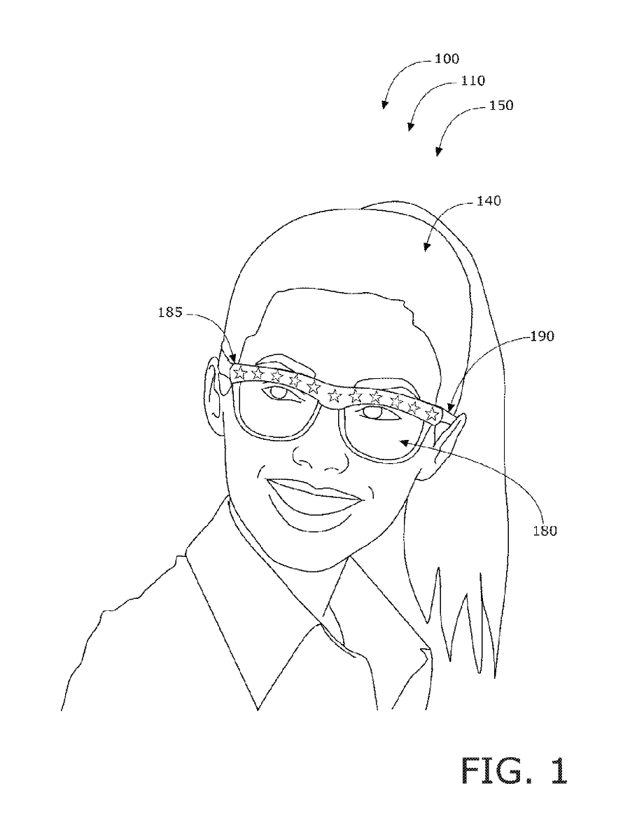

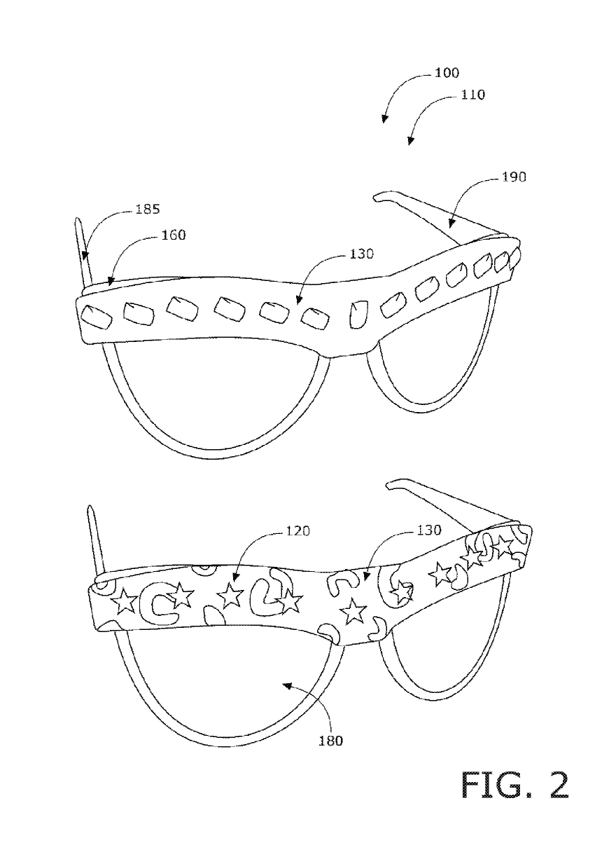

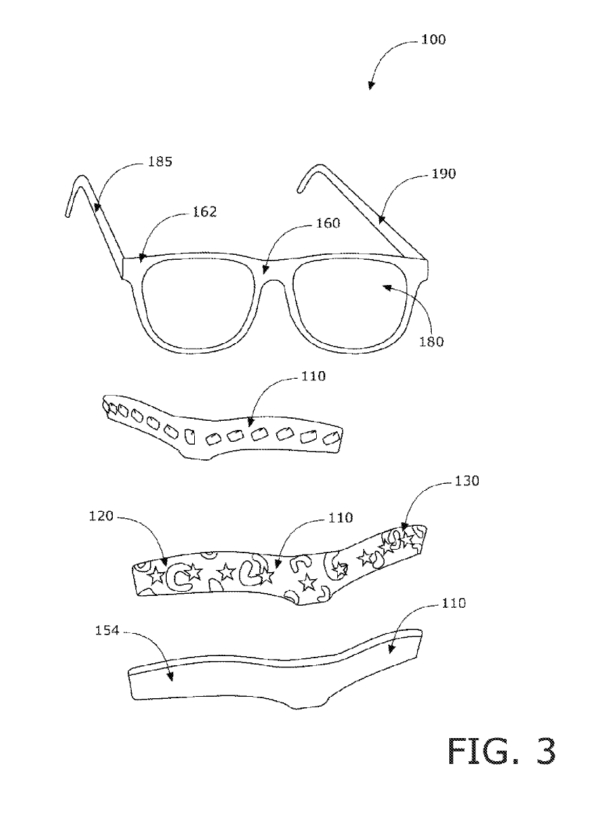

Referring now more specifically to the drawings by numerals of reference there is shown in FIGS. 1-3, various views of modular eyewear frame system 100 comprising: panel 110 having body 120 comprising front surface 130 and back surface 154. Modular eyewear frame system 100 comprises panel 100. Panel 100 comprises body 120. Body 120 is defined by front surface 130 and back surface 154. Panel 100 is adapted to removeably couple via adhering to top front border 162 of eyewear frame 160. Modular eyewear frame system 100 is useful for providing an adaptable eyewear frame 160 accessory to be attached over eyewear frame 160 to provide a means for modularly attaching panels 110 to conceal top front border 162 from view.

Panel 110 is preferably reusable. Eyewear frame 160 is adapted to receive panel 110 with a plurality of decorative designs. Panel 110 comprises a plurality of concealing means. Panel 110 may comprises leather; and/or synthetic texture. Adhering comprises an adhesive substance and the adhesive substance is preferably reusable. Adhesive substance may comprise glue, cellulose adhesive, mucilage, and/or adhesive paste.

Panel 110 contours to top front border 162 of eyewear frame 162. Panel 110 extends from top front border 162 of eyewear frame 160 to top-edge of each lens 180 of eyewear frame 160. Body of panel 110 is planar. Body 120 is flexible to contour to eyewear frame. Panel 110 is weather resistant. Panel 110 horizontally extends along top front border 162 of eyewear frame 160 from a first-arm 185 to a second-arm 190 of glasses member.

Modular eyewear frame 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different functional decorative and structural combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A modular eyewear frame system comprising:
a panel having;
a body comprising;
a front surface; and
a back surface;
wherein said modular eyewear frame system comprises said panel;
wherein said panel comprises said body;
wherein said body is defined by said front surface and said back surface;
wherein said panel is adapted to removeably couple via adhering to a top front border of an eyewear frame; and
wherein said modular eyewear frame system is useful for providing an adaptable eye frame accessory to be attached over said eyewear frame to provide a means for modularly attaching said panels to conceal said top front border from view.

2. The modular eyewear frame system of claim 1 wherein said panel is reusable.

3. The modular eyewear frame system of claim 1 wherein said eyewear frame is adapted to receive said panel with a plurality of decorative designs.

4. The modular eyewear frame system of claim 1 wherein said panel comprises a plurality of concealing means.

5. A modular eyewear frame system of claim 4 wherein said panel comprises leather.

6. The modular eyewear frame system of claim 1 wherein said panel comprises synthetic texture.

7. The modular eyewear frame system of claim 1 wherein said adhering comprises an adhesive substance.

8. The modular eyewear frame system of claim 7 wherein said adhesive substance is reusable.

9. The modular eyewear frame system of claim 7 wherein said adhesive substance comprises glue.

10. The modular eyewear frame system of claim 7 wherein said adhesive substance comprises cellulose adhesive.

11. The modular eyewear frame system of claim 7 wherein said adhesive substance comprises mucilage.

12. The modular eyewear frame system of claim 7 wherein said adhesive substance comprises adhesive paste.

13. The modular eyewear frame system of claim 1 wherein said panel contours to said top front border of said eyewear frame.

14. The modular eyewear frame system of claim 1 wherein said panel extends from said top front border of said eyewear frame to top-edge of each lens of said eyewear frame.

15. The modular eyewear frame system of claim 1 wherein said body of said panel is planar.

16. The modular eyewear frame system of claim 1 wherein said body is flexible to contour to said eyewear frame.

17. The modular eyewear frame system of claim 1 wherein said panel is weather resistant.

18. The modular eyewear frame system of claim 1 wherein said panel horizontally extends along said top front border of said eyewear frame from a first-arm to a second-arm of glasses member.

19. A modular eyewear frame system comprising:
a panel having;
a body comprising;
a front surface; and
a back surface;
wherein said modular eyewear frame system comprises said panel;
wherein said panel is weather resistant;
wherein said panel horizontally extends along said top front border of said eyewear frame from a first-arm to a second-arm of glasses member;
wherein said panel comprises said body;
wherein said body is defined by said front surface and said back surface;
wherein said body of said panel is planar;
wherein said body is flexible to contour to said eyewear frame;
wherein said panel is adapted to removeably couple via adhering to a top front border of an eyewear-frame;
wherein said panel contours to said top front border of said eyewear frame;
wherein said panel extends from said top front border of said eyewear frame to top-edge of each lens of said eyewear frame;
wherein said adhering comprises an adhesive substance;
wherein said adhesive substance is reusable;
wherein said adhesive substance comprises adhesive paste;
wherein said eyewear-frame is adapted to receive said panel with a plurality of decorative designs;
wherein said panel is reusable;
wherein said panel comprises synthetic texture;
wherein said panel comprises a plurality of concealing means; and
wherein said modular eyewear frame system is useful for providing an adaptable eye frame accessory to be attached over said eyewear frame to provide a means for modularly attaching said panels to conceal said top front border from view.
